(19) United States
(12) Patent Application Publication
(10) Pub. No.: US 2010/0005013 A1
(43) Pub. Date: Jan. 7, 2010

(54) METHODS AND SYSTEMS FOR DETECTING FRAUDULENT TRANSACTIONS IN A CUSTOMER-NOT-PRESENT ENVIRONMENT

(75) Inventor: Christopher J. Uriarte, Hoboken, NJ (US)

Correspondence Address: ROPES & GRAY LLP, PATENT DOCKETING 39/41, ONE INTERNATIONAL PLACE, BOSTON, MA, 02110-2624, US

(73) Assignee: Retail Decisions, Inc., Edison, NJ (US)

(21) Appl. No.: 12/398,117

(22) Filed: Mar. 4, 2009

Related U.S. Application Data
(60) Provisional application No. 61/133,973, filed on Jul. 3, 2008.

(51) Int. Cl. G06Q 10/00; G06Q 40/00

(52) U.S. Cl. 705/30

(57) ABSTRACT

The invention relates, in various aspects, to systems and methods for detecting fraudulent transactions. A server receives transaction data corresponding to a plurality of customer-not-present (“CNP”) transactions, after a first batch process and before a second batch process. A real-time fraud detection processor is configured for processing the transaction data and data obtained during the first batch process and, for each CNP transaction, outputting an authorization decision of the respective CNP transaction. A batch fraud detection processor is configured for executing the second batch process by collectively processing the transaction data and data obtained during the processing of the transaction data by the real-time fraud detection processor.

### CROSS-REFERENCE TO RELATED APPLICATION

This application claims the benefit of U.S. Provisional Application Ser. No. 61/133,973, filed Jul. 3, 2008, the entire contents of which are incorporated herein by reference.

### BACKGROUND

Detecting payment fraud, such as credit card fraud, remains a challenge to merchants. This is particularly true in a customer-not-present (“CNP”) environment, where a payment instrument (e.g. credit card, check, gift card) is not present at the time of purchase. For example, in the case of a customer-not-present credit card transaction, legal cardholder authorization is not obtained via signature. As another example, in the case of a customer-not-present electronic check transaction, a physical check is not presented in order to complete the purchase. CNP merchants typically conduct transactions in mail order and telephone order (“MOTO”) environments and/or over the Internet. The proliferation of such Internet commercial transactions, known as e-Commerce, over the past few years has provided a new avenue for criminals to perpetrate financial fraud using stolen payment instrument information, such as stolen credit card information. Traditionally, credit card transactions have occurred in a face-to-face payment environment, known as “customer-present” (“CP”) transactions, where store clerks have the ability to verify signatures, inspect the quality of the card presented, and ask the cardholder for subsequent identification. In the CNP environment, however, this is not possible, limiting a merchant's ability to verify that a purchase via a credit card or other payment instrument has been authorized by the owner of the card.

Unfortunately for merchants, the current payment instrument authorization environment does not always successfully identify fraudulent transactions. For example, assuming a credit card is yet to be reported stolen and its credit limit has not been exceeded, a significant likelihood exists that a fraudulent credit card transaction will be accepted. As a result, a need remains for systems and methods to more accurately detect transactions that should be rejected as fraudulent.

### SUMMARY

Accordingly, in one aspect, the invention relates to a computerized method of detecting fraudulent transactions. The computerized method includes receiving, at a server, transaction data corresponding to a plurality of customer-not-present (“CNP”) transactions, after a first batch process and before a second batch process. A real-time fraud detection processor processes the transaction data and data obtained during the first batch process and, for each CNP transaction of the plurality of CNP transactions, outputs an authorization decision of the respective CNP transaction. A batch fraud detection processor executes the second batch process by collectively processing the transaction data and data obtained during the processing of the transaction data by the real-time fraud detection processor. The data obtained during the processing of the transaction data by the real-time fraud detection processor may include at least one of the authorization decisions outputted by the real-time fraud detection processor. In some embodiments, the batch fraud detection processor outputs a report including a list of transactions found to be fraudulent by the batch fraud detection processor and accepted by the real-time fraud detection processor.

In some embodiments, a memory stores the data obtained during the first batch processes, where the stored data is accessible by the real-time fraud detection processor. In some embodiments, a memory stores the data obtained during the processing of the transaction data by the real-time fraud detection processor, where the stored data is accessible by the batch fraud detection processor.

In some embodiments, the processing by the real-time fraud detection processor includes executing one or more risk assessment modules. An output of the one or more risk assessment modules may depend on the data obtained during the first batch process. The data obtained during the processing of the transaction data by the real-time fraud detection processor may include an output of the one or more risk assessment modules.

In some embodiments, the processing by the batch fraud detection processor comprises executing one or more risk assessment modules. An output of the one or more risk assessment modules may depend on the data obtained during the processing of the transaction data by the real-time fraud detection processor.

According to another aspect, the invention relates to a system for detecting fraudulent transactions. A server receives transaction data corresponding to a plurality of customer-not-present (“CNP”) transactions, after a first batch process and before a second batch process. A real-time fraud detection processor is configured for processing the transaction data and data obtained during the first batch process and, for each CNP transaction, outputting an authorization decision of the respective CNP transaction. A batch fraud detection processor is configured for executing the second batch process by collectively processing the transaction data and data obtained during the processing of the transaction data by the real-time fraud detection processor.

### BRIEF DESCRIPTION OF DRAWINGS

In the detailed description which follows, reference will be made to the attached drawings, in which:

FIG. 1 depicts an illustrative system for detecting fraudulent transactions in a customer-not-present environment, according to one aspect of the invention;

FIG. 2 depicts a block diagram of a computer architecture suitable for implementing various computing devices incorporated into the system depicted in FIG. 1;

FIG. 3a depicts a block diagram of an illustrative system for providing real-time fraud detection, according to one aspect of the invention;

FIG. 3b depicts a block diagram of another illustrative system for providing real-time fraud detection, according to one aspect of the invention;

FIG. 4 depicts a block diagram of an illustrative system for providing real-time and batch fraud detection, according to one aspect of the invention; and

FIG. 5 depicts a flowchart for an illustrative method for detecting fraudulent transactions in a customer-not-present environment, according to one aspect of the invention.

### DETAILED DESCRIPTION

To provide an overall understanding of the invention, certain illustrative embodiments will now be described. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

Methods and systems for detecting fraudulent transactions in a customer-not-present environment are provided. Fraudulent transaction detection includes both real-time fraud detection, configured to provide an authorization decision soon after a transaction, and batch fraud detection, for collectively processing a plurality of transactions that have occurred over a period of time to generate a batch fraud detection report. Real-time fraud detection may use information provided as a result of batch fraud detection and vice versa. Real-time fraud detection is advantageous from a customer service standpoint as it provides an authorization decision soon after a transaction, without having to wait for a predetermined point in time. Batch fraud detection is advantageous because it has the ability to evaluate transactions based on future transaction activity.

A “customer-not-present” environment, as used herein, may be any payment environment in which the payment instrument being used is not physically accessible to the entity to whom the payment instrument is being proffered. Exemplary payment instruments include credit cards, debit cards, check, and gift certificates or cards. A “transaction,” as used herein, may be any activity between two or more entities in which goods or services are exchanged for money and involving a payment instrument capable of being used in a customer-not-present environment.

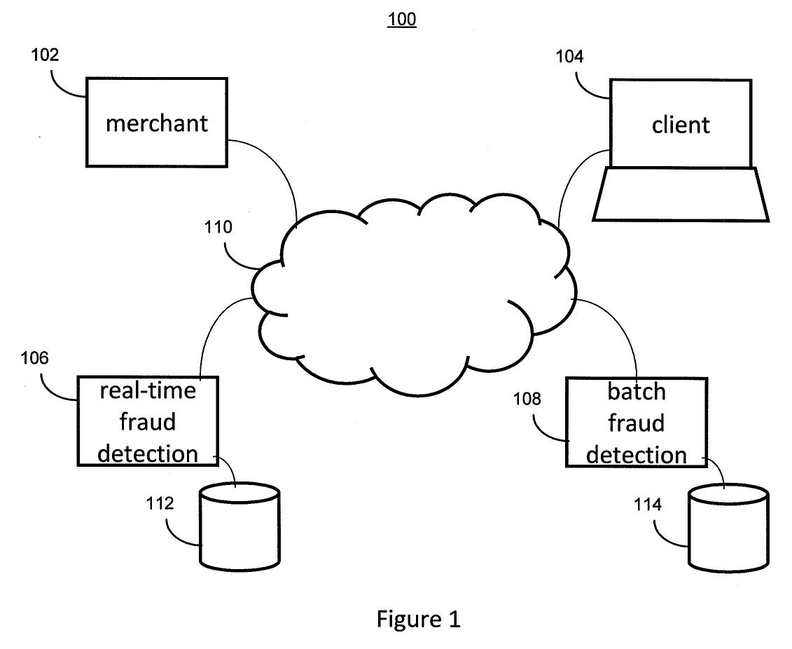

FIG. 1 depicts an illustrative system 100 for detecting fraudulent transactions in a customer-not-present environment, according to one aspect of the invention. The system 100 includes a merchant device 102, a client 104, a real-time fraud detection processor 106, and a batch fraud detection processor 108, which communicate over one or a combination of communications networks 110. The communication network 110 may be wired, wireless, or a combination thereof. They may be publicly accessible, such as the Internet, or part of a private communications network. Communications over the communication network 110 may be encrypted for reasons of security. The merchant device 102 conducts a transaction with a client 104 and transmits transaction data corresponding to the transaction to the real-time fraud detection processor 106 and/or a batch fraud detection processor 108 for processing. The real-time fraud detection processor 106 and batch fraud detection processor 108 have corresponding storage devices 112 and 114, respectively, for storing information received and/or generated by the processors.

The merchant device 102 conducts a transaction with clients, such as client 104, by exchanging information via the communication network 110. In some embodiments, the merchant device 102 is a server, the client 104 is a web client, and the communications network 110 is the Internet. The merchant device 102 accepts a request, such as an HTTP request, from the client 104 indicating a purchase by a user of the client 104. In some embodiments, the request arises from a phone order or mail order and is received by the merchant device 102 by, for example, manual entry via a user interface or an automated voice recognition, dual-tone multi-frequency (DTMF), or Session Initiation Protocol (SIP) enabled system. The request includes data identifying a payment instrument via which the purchase is to be made. In some implementations, the payment instrument is a credit card, in which case the request includes a credit card number, a name of the credit card account holder, an expiration date of the credit card, a billing address associated with the credit card, and/or a credit card verification number. In response to the request, the merchant device 102 transmits transaction data corresponding to the transaction to the real-time fraud detection processor 106 and/or the batch fraud detection processor 108 for processing. The transaction data includes the data representative of the payment instrument received by the merchant device 102; data describing the purchase, such as the amount being paid, a transaction time at which the transaction occurred, an IP address of the client 104, a geographic location to which a product being purchased is to be sent, a shipping method for the product being purchased, and/or information about the product being purchased (e.g., product description, product SKU or other identifier, quantity purchased); and data describing the purchasing user, such as contact information (e.g., email address, billing address, phone number) and/or the length of time that the purchaser has been a customer of the merchant. In some embodiments, the merchant device 102 is a system associated with a seller of products or with a bank who issues the payment instrument.

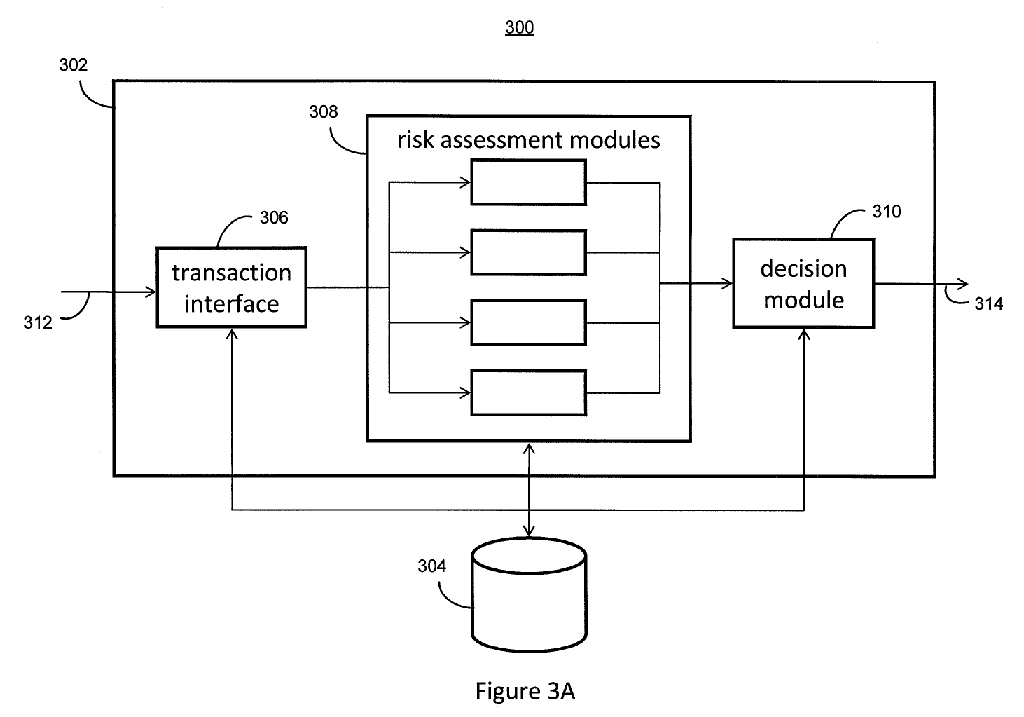

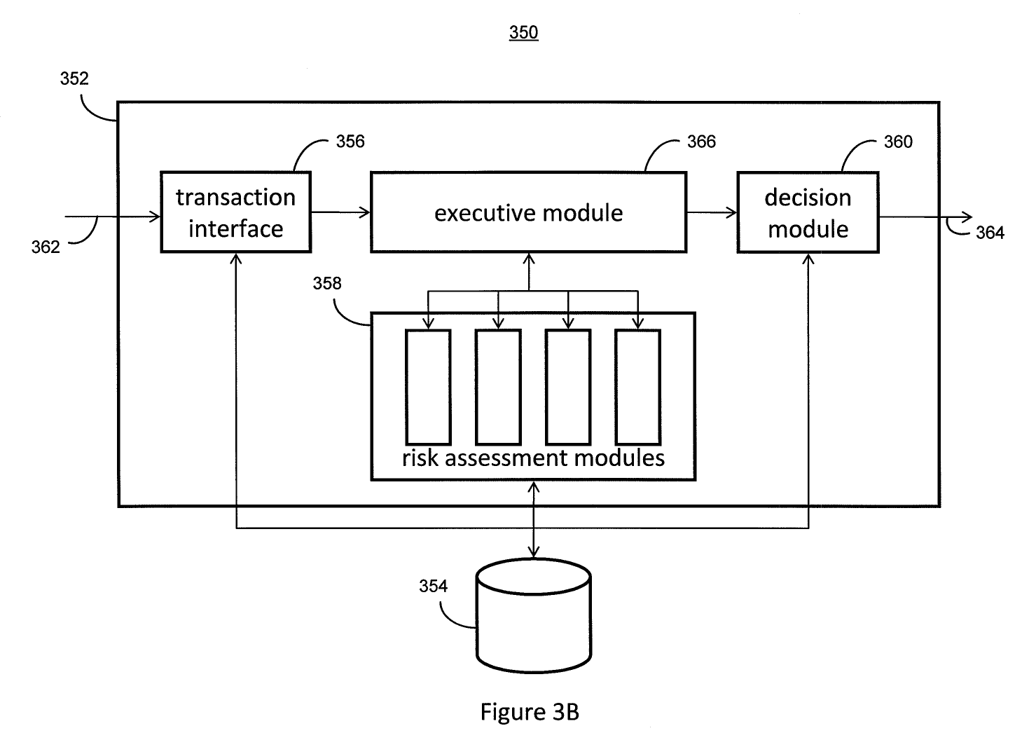

The real-time fraud detection processor 106 executes a real-time fraud detection process for determining an authorization decision based at least in part on the transaction data received from the merchant device 102. In particular, the real-time fraud detection process analyzes the transaction data for indications that the purchase may be fraudulent, determines based on its analysis an authorization decision which either accepts or rejects the transaction, and transmits the authorization decision for receipt by the merchant device 102. Exemplary real-time fraud detection processors are described further below with respect to FIGS. 3A and 3B. The real-time fraud detection process is configured to determine an authorization decision soon after the transaction time. In particular, the merchant device 102 generally transmits transaction data and the real-time fraud detection processor 106 determines and transmits an authorization decision without waiting for a predetermined point in time or for more transactions to occur. As such, authorization decisions determined by the real-time fraud detection process generally are not based on transaction data corresponding to transactions that occur after the transaction being authorized. The corresponding storage device 112 stores transaction data received by the real-time fraud detection processor 106 and/or authorization decisions determined by the real-time fraud detection processor 106. The stored data may be used by the real-time fraud detection processor 106 when processing transaction data received in the future and/or for transmitting information to other processors, such as the batch fraud detection processor 108, for use in fraud detection processing.

The batch fraud detection processor 108 executes a batch fraud detection process for generating a batch fraud detection report based at least in part on transaction data corresponding to a plurality of transactions. In some embodiments, the transaction data used to generate the batch fraud detection report correspond to transactions that occurred during a predetermined period of time. The transaction data corresponding to such transactions are transmitted to the processor 108 at a predetermined point in time, for example, at the end of the predetermined period of time. In some embodiments, the transaction data has been received by the real-time fraud detection processor 106, stored in storage device 112, and then transmitted by the processor 106 at the predetermined point in time for receipt by the processor 108. In some embodiments, the transaction data corresponds to a plurality of transactions conducted by one or more merchant devices 102 over the predetermined period of time. The batch fraud detection report may include authorization decisions for each transaction of the plurality of transactions, where each authorization decision may be based on transaction data corresponding to transactions that occur before and after the transaction being authorized.

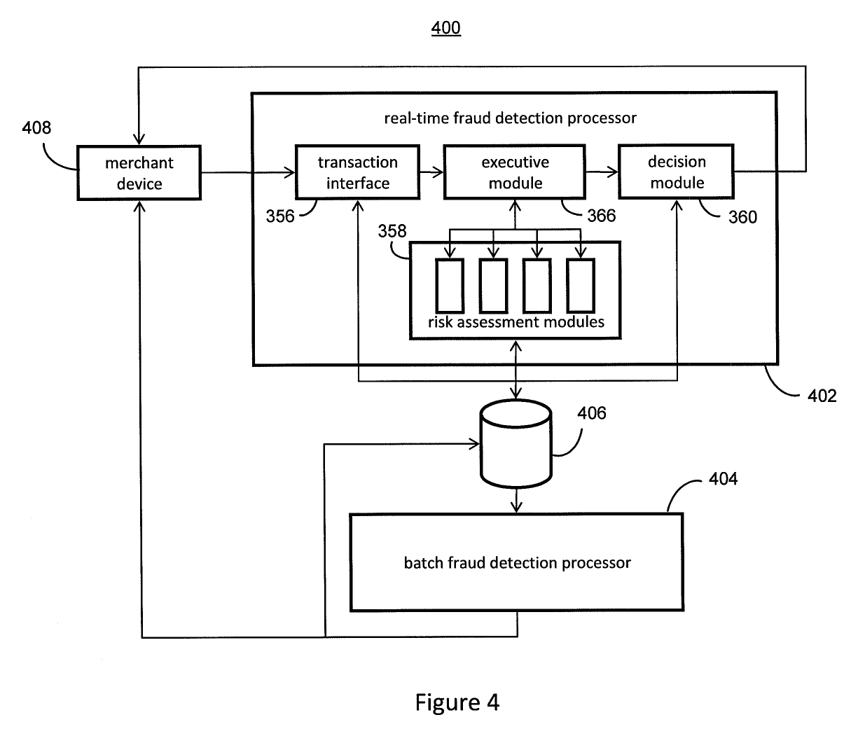

The batch fraud detection processor 108 may receive other information from the real-time fraud detection processor 106, such as authorization decisions determined by the processor 106, and generate batch fraud detection reports based on this other information. For example, it may be helpful for the processor 108 when analyzing a transaction to have information indicating that a future transaction involving the same payment instrument was rejected by the real-time fraud detection processor 106. Exemplary batch fraud detection processors are described further below with respect to FIG. 4. The corresponding storage device 114 stores transaction data received by the batch fraud detection processor 108 and/or batch fraud detection reports generated by the batch fraud detection processor 108. The stored data may be used by the batch fraud detection processor 108 when processing transaction data received in the future and/or for transmitting to other processors, such as the real-time fraud detection processor 106, for use in fraud detection processing.

In some embodiments, the processors 106 and 108 are located at geographic locations remote from one another and communicate via communication links of the communications network 110. In some embodiments, the processors 106 and 108 are colocated at the same geographic location. The processors 106 and 108 may be servers, or part of the same server. In some embodiments, the processors 106 and 108 are the same processor, namely a processor having instructions thereon for implementing a real-time fraud detection process and for implementing a batch fraud detection process. Similarly, the storage device 112 and storage device 114 may be geographically remote from one another, for example each may be colocated with its corresponding processor 106 and 108, respectively, or may be colocated at the same geographic location. They may be part of the same storage device. Exemplary storage devices include relational databases on magnetic disk drives, database servers, Redundant Array of Independent Disks (RAID) servers, and other non-volatile digital storage devices known in the art.

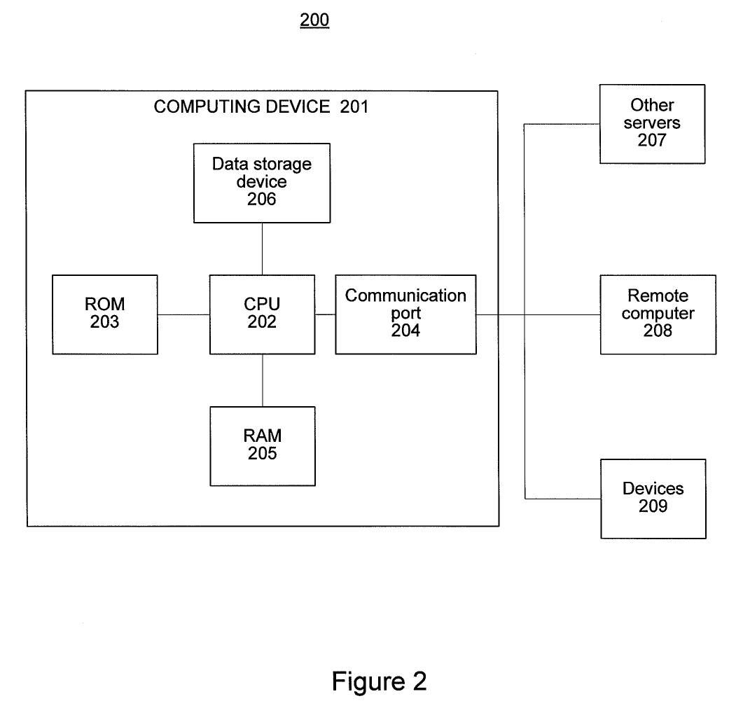

FIG. 2 is a block diagram of a computer architecture 200 suitable for implementing various computing devices 201 incorporated into the system 100, including, for example, servers and processors such as processors 106 and 108.

Computing device 201 comprises at least one central processing unit (CPU) 202, at least one read-only memory (ROM) 203, at least one communication port or hub 204, at least one random access memory (RAM) 205, and one or more databases or data storage devices 206. All of these later elements are in communication with the CPU 202 to facilitate the operation of the computing device 201. The computing device 201 may be configured in many different ways. For example, computing device 201 may be a conventional standalone server computer or alternatively, the function of server may be distributed across multiple computing systems and architectures.

Computing device 201 may be configured in a distributed architecture, wherein databases and processors are housed in separate units or locations. Some such servers perform primary processing functions and contain at a minimum, a general controller or a processor 202, a ROM 203, and a RAM 205. In such an embodiment, each of these servers is attached to a communications hub or port 204 that serves as a primary communication link with other servers 207, client or user computers 208 and other related devices 209. The communications hub or port 204 may have minimal processing capability itself, serving primarily as a communications router. A variety of communications protocols may be part of the system, including but not limited to: Ethernet, SAP, SAS™, ATP, BLUETOOTH™, GSM and TCP/IP.

The CPU 202 comprises a processor, such as one or more conventional microprocessors and one or more supplementary co-processors such as math co-processors. The CPU 202 is in communication with the communication port 204 through which the CPU 202 communicates with other devices such as other servers 207, user terminals 208, or devices 209. The communication port 204 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices

The CPU 202 is also in communication with the data storage device 206. The data storage device 206 may comprise an appropriate combination of magnetic, optical and/or semiconductor memory, and may include, for example, RAM, ROM, flash drive, an optical disc such as a compact disc and/or a hard disk or drive. The CPU 202 and the data storage device 206 each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing. For example, the CPU 202 may be connected to the data storage device 206 via the communication port 204.

The data storage device 206 may store, for example, (i) a program (e.g., computer program code and/or a computer program product) adapted to direct the CPU 202 in accordance with the present invention, and particularly in accordance with the processes described in detail hereinafter with regard to the CPU 202; (ii) databases adapted to store information that may be utilized to store information required by the program.

The program may be stored, for example, in a compressed, an uncompiled and/or an encrypted format, and may include computer program code. The instructions of the program may be read into a main memory of the processor from a computer-readable medium other than the data storage device 206, such as from a ROM 203 or from a RAM 205. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as responding to requests, generating authorization decisions regarding a transaction, executing risk assessment tests on transaction data, and executing real-time and/or batch fraud detection processes. The program also may include program elements such as an operating system, a database management system and “device drivers” that allow the processor to interface with computer peripheral devices (e.g., a video display, a keyboard, a computer mouse, etc.).

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer 208. The remote computer 208 can load the instructions into its dynamic memory and send the instructions over an Ethernet connection, cable line, or even telephone line using a modem. A communications device 204 local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary

FIG. 3A depicts a block diagram of an illustrative system 300 for providing real-time fraud detection, according to one aspect of the invention. The system 300 includes a real-time fraud detection processor 302 and storage device 304, which may be part of the processor 106 and storage device 112, respectively, described above with respect to FIG. 1. The processor 302 includes a transaction interface 306, a set of risk assessment modules 308, and a decision module 310. The transaction interface 306 is configured to receive transaction data 312 transmitted by a merchant device, such as merchant device 102 of FIG. 1. The set of risk assessment modules 308 is configured to analyze transaction data received by the transaction interface 306 for indications that a purchase may be fraudulent. In some embodiments, the modules 308 are software modules implemented by the processor 302. The decision module 310 is configured to determine, based on outputs of the risk assessment modules 308 regarding a transaction, an authorization decision 314 that either accepts or rejects the transaction. The storage device 304 stores transaction data received by the transaction interface 306, outputs of the risk assessment modules 308, and/or authorization decisions determined by the decision module 310. The system 300 may be used in conjunction with a system for providing batch fraud detection processing. For example, information stored on the storage device 304, such as authorization decisions or transaction data, may be shared with a system for batch fraud detection processing.

Generally, risk assessment modules may require different information contained within the transaction data corresponding to a transaction and different formatting for the information. The transaction interface 306 serves to normalize and/or clean received transaction data. In particular, the transaction interface 306 can receive transaction data in multiple formats and format received transaction data for transmitting to the risk assessment modules 308. The formatting performed may depend on which risk assessment module is to receive the formatted data. In some embodiments, the transaction interface 306 reformats particular portions, elements, or fields of the received transaction data 312, such as by removing excess whitespace, removing invalid characters, or ensuring a particular type of data is consistent with a predetermined form (e.g., changing any dates to a numerical representation where the first 2 characters represent day, the next 2 characters represent month, and the last 4 characters represent year). In some embodiments, the transaction interface 306 rejects received transaction data 312 that is misformatted. In particular, upon receipt of transaction data that the interface 306 cannot properly format for transmittal to the risk assessment modules 308, the transaction interface 306 may initiate a message for receipt by the merchant device that transmitted the misformatted transaction data to notify the merchant device of the error.

The set of risk assessment modules 308 execute a plurality of techniques, each of which generally evaluates a particular characteristic of a transaction, as represented by the corresponding transaction data, and generates, as a result of the evaluation, an output indicative of whether a purchase is fraudulent. Exemplary techniques include business rules, negative data techniques, geolocation techniques, and pattern detection techniques, described further below. In some embodiments, the set of risk assessment modules 308 access data stored on storage device 304 to generate outputs. For example, historical transaction data used for business rules, pattern detection techniques, or negative data lists may be stored on storage device 304.

Business rules analyze transaction data to determine whether the transaction violates a constraint and generate an output indicating a high likelihood of fraud if the constraint is violated. Exemplary constraint violations include involving an amount to be paid that exceeds some particular limit, using a payment instrument that has been used more than a specified amount of times within a particular time period, and requesting an overnight shipping method to a location outside the United States.

Negative data techniques compare transaction data to negative data lists of credit card numbers, shipping addresses, billing addresses, email addresses, or other types of transaction data that are considered to indicate a heightened likelihood that the transaction is fraudulent. For example, a credit card number that has been used in a number of transactions that have been rejected or has been reported stolen may be added to the negative data list of credit card numbers.

Geolocation techniques process location information of the entity making a purchase, for example by deriving a geographic location (e.g., city, state, and country) based on the IP address of the client 104 of FIG. 1, to compare to other location information known about authorized users of the payment instrument. For example, a purchasing entity located in a different continent from the billing address of the payment instrument may indicate fraud.

Pattern detection techniques involve the use of neural networks and/or statistical models to compare transaction data to past transaction data to detect inconsistencies and/or to determine a degree of similarity to patterns usually consistent with fraud. Pattern detection techniques may generate a quantitative risk score indicative of a likelihood that a transaction is fraudulent.

The decision module 310 receives outputs from the set of risk assessment modules 308, where, in one implementation, each output is indicative of a likelihood that a transaction is fraudulent. Based on the outputs, the decision module 310 determines an authorization decision that accepts or rejects the transaction. In some embodiments, instead of outputting a likelihood, each of the risk assessment modules 308 outputs data indicating one of a pass or a fail and the decision module 310 rejects the transaction if the number of outputs indicating a fail exceed some predetermined threshold. For example, the decision module 310 may reject the transaction if any of the outputs indicates a fail. In another example, the decision module 310 rejects the transaction if a majority of outputs indicates a fail. In still another example, the decision module 310 rejects the transaction if a fixed number, greater than one, of outputs indicates a fail. Conversely, in alternative implementations, the decision module 310 accepts a transaction if the number of outputs indicating a pass exceeds a predetermined or dynamically determined threshold. Conceptually, a results can be viewed as a score card, with a threshold score being required for acceptance of a transaction.

FIG. 3B depicts a block diagram of another illustrative system 350 for providing real-time fraud detection, according to one aspect of the invention. The system 350 includes a real-time fraud detection processor 352 and storage device 354, which may be part of the processor 106 and storage device 112, respectively, described above with respect to FIG. 1. The processor 352 includes a transaction interface 356 for receiving transaction data 362 transmitted by a merchant device, such as merchant device 102 of FIG. 1, an executive model 366 for interfacing with a set of risk assessment modules 358 for analyzing transaction data for indications that a purchase may be fraudulent, and a decision module 360 for determining, based on outputs of the risk assessment modules 358 regarding a transaction, an authorization decision 364 that either accepts or rejects the transaction. The storage device 354 stores transaction data received by the transaction interface 356, outputs of the risk assessment modules 358, and/or authorization decisions determined by the decision module 360. The system 350 may be used in conjunction with a system for providing batch fraud detection processing. For example, information stored on the storage device 354, such as authorization decisions or transaction data, may be shared with a system for batch fraud detection processing.

Generally, risk assessment modules may require different information contained within the transaction data corresponding to a transaction and different formatting for the information. The transaction interface 356, which may be similar to the transaction interface 306 of FIG. 3A, serves to normalize and/or clean received transaction data. In particular, the transaction interface 356 can receive transaction data in multiple formats and format received transaction data for transmitting to the executing module 366.

The executive module 366 distributes transaction data to and collects outputs from each risk assessment module. The executive module 366 formats transaction data for receipt by the risk assessment modules 358, which generally require different information contained within the transaction data corresponding to a transaction and different formatting for the information. The set of risk assessment modules 358 and their respective outputs may be similar to the modules 308 and outputs described above with respect to FIG. 3A. Outputs of the risk assessment modules 358 are transmitted by the executive module 366 to the decision module 360. In some embodiments, the executive module 366 normalizes the outputs before transmitting them to the decision module 360.

For example, the decision module determines, based on the outputs, an authorization decision that accepts or rejects the transaction. In various embodiments, the decision module 360 applies one of the score card analyses described above in relation to decision module 310.

In some embodiments, the real-time fraud detection processor 302 or 352 includes a general interfacing module (not shown) for interfacing the processor 302 or 352 with other processors such as a merchant server. For example, the general interfacing module may be capable of processing received data to extract the transaction data for receipt by the transaction interface 306 or 356. The general interfacing module may also be capable of receiving an authorization decision from the decision module 310 or 360 and reformatting it for receipt by the merchant device that transmitted its corresponding transaction data.

An exemplary system employing a set of risk assessment modules, such as in the systems 300 or 350 of FIGS. 3A and 3B, is the ReDShield multi-dimensional fraud prevention system developed by Transaction Retail Decisions.

FIG. 4 depicts a block diagram of an illustrative system 400 for providing real-time and batch fraud detection, according to one aspect of the invention. The system 400 includes a real-time fraud detection processor 402, a batch fraud detection processor 404, storage device 406, and a merchant device 408, which may be similar to processor 106, processor 108, storage device 112 or 114, and merchant device 102, respectively, of FIG. 1. The batch fraud detection processor 404 accesses data from the real-time fraud detection processor 402, such as data stored in the storage device 406, to perform fraud detection processing on batches of data corresponding to a plurality of transactions. The real-time fraud detection processor 402 may be similar to the processor 302 or 352 (as depicted) of FIGS. 3A and 3B, respectively. The real-time fraud detection processor 402 may access data from the batch fraud detection processor 404. The storage device 406 may be a single or multiple storage devices, which may be colocated or located at multiple geographic locations, and may store, similar to storage device 304 and 354 of FIGS. 3A and 3B, data related to a transaction from the real-time fraud detection processor 402, such as transaction data, risk assessment module outputs, and authorization decisions. The storage device 406 may also store data from the batch fraud detection processor 404.

At a predetermined point in time, a batch of data is transmitted to the batch fraud detection processor 404 for processing. The transmitted batch of data corresponds to a plurality of transactions that have been processed by the processor 402. Transmitted data may include transaction data, risk assessment module outputs, authorization decisions, and any other data relating to any transaction of the plurality of transactions. The transmitted data may have been stored in storage device 406 prior to transmittal. Batches of data may be transmitted to the batch fraud detection processor 404 on an hourly or daily basis, where the data is related to transactions that took place in the immediately preceding hour or day, respectively. Other durations of periods of time may be implemented, including irregular periods whose durations vary over time. For example, batch periods may be shorter during times of peak transactions and longer during periods of low transactions. The point in time at which data is transmitted may, instead of being fixed, depend on other factors such as a number of transactions received since the previous transmittal of data to the processor 404.

For each batch of data received by the batch fraud detection processor 404, the processor 404 generates, based on the received batch of data, a batch fraud detection report including information representative of a likelihood of fraud for each transaction associated with the batch of data. In some embodiments, the batch fraud detection processor 404 is similar to either the processor 302 or 352 of FIGS. 3A and 3B, respectively, but may determine for a particular transaction an authorization decision different from that of processor 402 for that particular transaction due to processor 404 having access to data relating to transactions that took place after that particular transaction. For example, business rules, negative data techniques, pattern detection techniques, and any other risk assessment techniques which use data relating to transactions other than the one being analyzed may generate different outputs given information about future transactions, such as whether those future transactions were accepted. A decision module of the processor 404 may determine an authorization decision for a particular transaction based on risk assessment module outputs that correspond to other transactions, in addition to outputs corresponding to the particular transaction. For example, a set of transactions may be related (e.g., involve the same payment instrument or shipping address) and may each violate a different business rule constraint. The violation of a single business rule constraint may be insufficient to reject a transaction, but the decision module may nevertheless reject the transaction based on the violations arising from the related transactions. In some embodiments, the batch fraud detection report includes a list of transactions accepted by the real-time fraud detection processor 402 but found to be fraudulent by the batch fraud detection processor.

Batch fraud detection reports are transmitted to the merchant device 408. In some embodiments, reports are stored on storage device 406. The real-time fraud detection processor 402 may use information from reports stored on storage device 406 when processing future transactions. In particular, risk assessment modules of the processor 402 may generate outputs based on information from batch fraud detection reports. For example, a credit card number for a transaction accepted by the real-time fraud detection processor 402 but found to be fraudulent by the batch fraud detection processor may be added to a negative data list of credit card numbers.

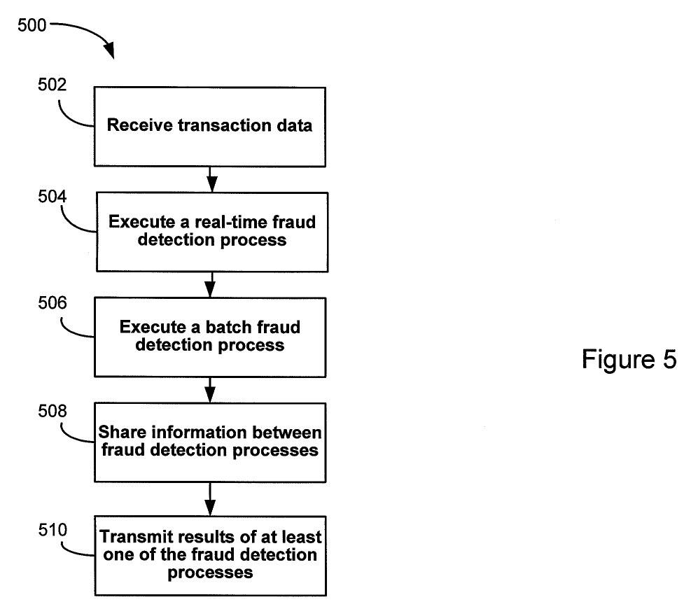

FIG. 5 depicts a flowchart for an illustrative method 500 for detecting fraudulent transactions in a customer-not-present environment, according to one aspect of the invention. The method 500 includes the steps of receiving transaction data 502, executing a real-time fraud detection process 504, and executing a batch fraud detection process 506. The method 500 includes the step of sharing information between a system executing the real-time fraud detection process and a system executing the batch fraud detection process 508 and/or the step of transmitting results of at least one of the fraud detection processes 510.

Transaction data received at step 502 describes or relates to one or more transactions and includes information sufficient to enable execution of the real-time and batch fraud detection processes of steps 504 and 506. Exemplary information included in transaction data is described above with respect to FIG. 1. At step 510, results of at least one of the fraud detection processes are transmitted to an entity from which the transaction data was received, such as a merchant or other party to the transaction.

At step 504, the real-time fraud detection process determines, based on information included in the transaction data received at step 502, an authorization decision which accepts or rejects a transaction described by or related to the transaction data. The real-time fraud detection process examines transaction data corresponding to a single transaction for indicators that the transaction may be fraudulent. In some embodiments, step 504 includes two steps: performing one or more risk assessment tests and determining an authorization decision. The one or more risk assessment tests, which are similar to the techniques described above with respect to the risk assessment modules of FIG. 3A, each generate an outcome indicative of a likelihood that a transaction is fraudulent. At least one of the risk assessment tests may be based on transaction data corresponding to one or more transactions that occurred prior to the one being examined. For example, a test may look for patterns formed by recent transactions each involving the same payment instrument as the transaction being examined. The authorization decision is then determined based on these outcomes via an algorithm such as those described above with respect to the decision module of FIG. 3A.

At step 506, the batch fraud detection process generates a batch fraud detection report based on information included in the transaction data received at step 502. The batch fraud detection process examines transaction data corresponding to a batch of transactions, such as transactions that have occurred over a predetermined period of time. The batch fraud detection report includes information representative of a likelihood of fraud for each transaction of the batch. In some embodiments, the process uses risk assessment tests similar to those of the real-time fraud detection process to generate the information in the report, as described above with respect to FIG. 4. In some embodiments, the report includes a list of transactions accepted by the real-time fraud detection processor but found to be fraudulent by the batch fraud detection process. Information in the report corresponding to a particular transaction may be generated based on transaction data corresponding to one or more previous transactions and/or other transactions of the batch, some of which may have occurred after the particular transaction. For example, a risk assessment test may determine a certain payment instrument has been stolen based on the pattern formed by transactions of the batch involving that payment instrument, in which case earlier transactions of the batch are deemed fraudulent based on later transactions of the batch.

At step 508, systems executing the fraud detection processes of steps 504 and 506 may share information, such as the results of each process. For example, the batch fraud detection process of step 506 may have access to authorization decisions determined by the real-time fraud detection process of step 504 and/or, conversely, the real-time fraud detection process of step 504 may have access to batch fraud detection reports generated by the batch fraud detection process of step 506. The results of each process are then based on information shared by the other process, such as is described above with respect to FIG. 4. For example, a report generated at step 506 corresponding to a batch of transactions may depend on authorization decisions determined at step 504 for those transactions. As another example, risk assessment tests executed by the process of step 504 may use information included in reports generated by the process of step 506.

The invention may be embodied in other specific forms without departing from the spirit or essential characteristics thereof. The forgoing embodiments are therefore to be considered in all respects illustrative, rather than limiting of the invention. Applicants consider all operable combinations of the embodiments disclosed herein to be patentable subject matter.

1. A computerized method of detecting fraudulent transactions comprising:
receiving, at a server, transaction data corresponding to a plurality of customer-not-present (“CNP”) transactions, after a first batch process and before a second batch process;
processing, by a real-time fraud detection processor, the transaction data and data obtained during the first batch process;
for each CNP transaction of the plurality of CNP transactions, outputting, by the real-time fraud detection processor, an authorization decision of the respective CNP transaction; and
executing the second batch process by collectively processing, by a batch fraud detection processor, the transaction data and data obtained during the processing of the transaction data by the real-time fraud detection processor.

2. The computerized method of claim 1, comprising outputting, by the batch fraud detection processor, a report comprising a list of transactions found to be fraudulent by the batch fraud detection processor and accepted by the real-time fraud detection processor.

3. The computerized method of claim 1, comprising storing the data obtained during the first batch processes in a memory, wherein the stored data is accessible by the real-time fraud detection processor.

4. The computerized method of claim 1, comprising storing the data obtained during the processing of the transaction data by the real-time fraud detection processor in a memory, wherein the stored data is accessible by the batch fraud detection processor.

5. The computerized method of claim 1, wherein the data obtained during the processing of the transaction data by the real-time fraud detection processor comprises at least one of the authorization decisions outputted by the real-time fraud detection processor.

6. The computerized method of claim 1, wherein the processing by the real-time fraud detection processor comprises executing at least one risk assessment module.

7. The computerized method of claim 6, wherein an output of the at least one risk assessment module depends on the data obtained during the first batch process.

8. The computerized method of claim 6, wherein the data obtained during the processing of the transaction data by the real-time fraud detection processor comprises an output of the at least one risk assessment module.

9. The computerized method of claim 1, wherein the processing by the batch fraud detection processor comprises executing at least one risk assessment module.

10. The computerized method of claim 9, wherein an output of the at least one risk assessment module depends on the data obtained during the processing of the transaction data by the real-time fraud detection processor.

11. A system for detecting fraudulent transactions comprising:
a server for receiving transaction data corresponding to a plurality of customer-not-present (“CNP”) transactions, after a first batch process and before a second batch process;
a real-time fraud detection processor configured for
processing the transaction data and data obtained during the first batch process, and
for each CNP transaction of the plurality of CNP transactions, outputting an authorization decision of the respective CNP transaction; and
a batch fraud detection processor configured for executing the second batch process by collectively processing the transaction data and data obtained during the processing of the transaction data by the real-time fraud detection processor.

12. The system of claim 11, wherein the batch fraud detection processor is further configured for outputting a report comprising a list of transactions found to be fraudulent by the batch fraud detection processor and accepted by the real-time fraud detection processor.

13. The system of claim 11, comprising a memory for storing the data obtained during the first batch processes, wherein the stored data is accessible by the real-time fraud detection processor.

14. The system of claim 11, comprising a memory for storing the data obtained during the processing of the transaction data by the real-time fraud detection processor, wherein the stored data is accessible by the batch fraud detection processor.

15. The system of claim 11, wherein the data obtained during the processing of the transaction data by the real-time fraud detection processor comprises at least one of the authorization decisions outputted by the real-time fraud detection processor.

16. The system of claim 11, wherein the real-time fraud detection processor is configured for executing at least one risk assessment module.

17. The system of claim 16, wherein an output of the at least one risk assessment module depends on the data obtained during the first batch process.

18. The system of claim 16, wherein the data obtained during the processing of the transaction data by the real-time fraud detection processor comprises an output of the at least one risk assessment module.

19. The system of claim 11, wherein the batch fraud detection processor is configured for executing at least one risk assessment module.

20. The system of claim 19, wherein an output of the at least one risk assessment module depends on the data obtained during the processing of the transaction data by the real-time fraud detection processor.
